(19) United States
(12) Patent Application Publication
(10) Pub. No.: US 2024/0300827 A1
(43) Pub. Date: Sep. 12, 2024

(54) WATER REUSE AND CONTROL SYSTEM FOR INDUSTRIAL TEXTILE CLEANING FACILITIES

(71) Applicant: Ecolab USA Inc., Saint Paul, MN (US)

(72) Inventors: Russell Shawn Berman, Tampa, FL (US); Kaustav Ghosh, Woodbury, MN (US); Craig Coldiron, Chesterfield, MO (US); Eugene Tokhtuev, Woodbury, MN (US); Nathan Ortmann, Minneapolis, MN (US)

(21) Appl. No.: 18/600,489

(22) Filed: Mar. 8, 2024

Related U.S. Application Data
(60) Provisional application No. 63/489,111, filed on Mar. 8, 2023.

(51) Int. Cl. C02F 1/00; C02F 1/24; C02F 101/30; C02F 103/00

(52) U.S. Cl. CPC C02F 1/008; C02F 1/001; C02F 1/24; C02F 2101/308; C02F 2103/002; C02F 2201/002; C02F 2209/003; C02F 2209/10; C02F 2209/11; C02F 2303/24

(57) ABSTRACT

A water recycle system may be implemented to analyze and selectively recycle wastewater generated by an industrial textile washer. In some examples, wastewater generated by the industrial textile washer undergoes various treatment processes, such as chemical treatments (e.g., addition of flocculants, chelating agents) and/or physical separation treatments (e.g., processing in a dissolved air floatation system to remove particulates). This can generate a clarified wastewater. One or more sensors can be positioned to measure characteristics of the clarified wastewater, such as the color of the clarified wastewater and corresponding tendency to stain textile articles if recycled to the washer. Based on measurements from the one or more sensors, the clarified wastewater can be recycled for reuse in the textile washer or, alternatively, discarded.

### RELATED APPLICATION

This application claims priority to U.S. Provisional Application No. 63/489,111, filed on Mar. 8, 2023, the entire contents of which are incorporated herein by reference.

### TECHNICAL FIELD

This disclosure relates to textile cleaning and, more particularly, to water use and control systems for textile cleaning.

### BACKGROUND

Operators in the commercial textile cleaning industry are continually challenged to process high volumes of textile articles that are often heavily soiled to produce hygienic and visually attractive items for reuse. Typical textiles that are processed in high volume commercial cleaning facilities include hospital articles (e.g., bed linens, surgical and patient garments, towels), hotel and hospitality articles (e.g., bed linens and toweling), and restaurant articles (e.g., table cloths, napkins).

Commercial textile cleaners typically use large, automated commercial washing machines to clean the textiles. These commercial washing machines may automatically add a series of different aqueous solutions to the textiles being processed, such as aqueous solutions containing quantities of alkaloid, detergent, bleach, starch, softener and/or sour, to clean and sanitize/disinfect the articles being processed. The concentration of the different chemical agents introduced into the washing machine during processing may be preprogrammed based on the expected level of soil on the textiles being processed and the characteristics of the textiles being processed (e.g., color, desire softness).

Because of the high volumes of textile articles processed in a commercial textile care facility, the facility uses a significant amount of water. After being discharged from a commercial washing machine, that wastewater is often processed through onsite wastewater treatment processes, for example to remove particulates and/or to chemically balance or neutralize the wastewater. The resulting treated wastewater may then be discharged to a municipal sewer system for further treatment or otherwise disposed.

### SUMMARY

In general, this disclosure is directed to water recycle and reuse systems and associated techniques for industrial textile washing facilities. In some examples, a water recycle system may be implemented to analyze and selectively recycle wastewater generated by one or more industrial textile washers. In some examples, wastewater generated by the industrial textile washer undergoes various treatment processes, such as chemical treatments (e.g., addition of flocculants, chelating agents) and/or physical separation treatments (e.g., processing in a dissolved air floatation system to remove particulates, processing through a filtration system). This can generate a clarified wastewater. One or more sensors can be positioned to measure characteristics of the clarified wastewater, such as the color of the clarified wastewater and corresponding tendency to stain textile articles if recycled to the washer, the turbidity or total suspended solids of the clarified water indicating the amount liberated soil in the water, and/or other characteristics. Based on measurements from the one or more sensors, the clarified wastewater can be recycled for reuse in the textile washer or, alternatively, discarded. In this way, a volume of wastewater that previously all would have been discarded can be segregated between a portion unsuitable for recycle that is still discarded and a portion suitable for recycle and reuse that can be captured. Given the large volumes of water used by industrial textile washing facilities, recapturing at least a portion of the water that otherwise would have been discarded for reuse can deliver impactful environmental and economic benefits.

While a water recovery system for a textile washing facility can have a variety of different implementations, in some examples, the system includes various features to control the delivery and/or the quality of clarified water analyzed by one or more sensors. For example, the system can include one or more supply control devices, such as pumps, valves, or the like to selectively control delivery of the clarified water to either a recycle fluid path for return to a textile washer or a discharge fluid path for final disposition of the clarified water.

As another example, the system may include one or more sensors to measure one or more characteristics of that portion of water identified for recycle back to the textile water (e.g., that portion of the water designated for recycle based on prior sensor measurement of the clarified water). For example, system can include various sensors such as a pH sensor, conductivity sensor, oxidation-reduction potential sensor, or the like to measure a corresponding characteristic of the that portion of the water designated for recycle (e.g., the water delivered to a recycle fluid path by a supply control device). The system may automatically implement various control actions in response to one or more measured characteristics of the water designated for recycle. For example, the system may control delivery of an acid, a base, fresh water, or other agent that modifies the composition of the reuse water, e.g., to adjust the composition of the reuse water to be within one or more target thresholds corresponding to a water suitable for use in the textile washer.

In example, a method is described that involves receiving wastewater generated by one or more textile washers, processing the wastewater to remove particulates from the wastewater to generate a clarified water, and measuring one or more characteristics of the clarified water to provide one or more measured characteristics of the clarified water. The method also involves controlling supply of the clarified water based on the one or more measured characteristics to either (a) return the clarified water to the one or more textile washers for reuse or (b) discard the clarified water.

In another example, a water recovery system for a textile washing facility is described. The system includes one or more textile washers configured to wash textile articles and produce a wastewater and a waste water treatment system fluidly connected to the one or more textile washers and configured to receive the wastewater produced by the one or more textile washers, remove particulates from the wastewater, and generate a clarified water. The system also includes one or more sensors positioned to measure one or more characteristics of the clarified water to provide one or more measured characteristics of the clarified water, a supply control device configured to control return of the clarified water to the one or more textile washers for reuse, a waste discharge, and a controller. The controller is communicatively coupled to the one or more sensors and the supply control device and configured to receive data from the one or more sensors indicative of the one or more measured characteristics of the clarified water and control the supply control device based on the one or more measured characteristics to either (a) return the clarified water to the one or more textile washers for reuse or (b) discard the clarified water to the waste discharge.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram of an example water recovery system for a textile washing facility.

FIG. 2 is a plot of turbidity versus time for a clarified water measured downstream of a dissolved air floatation system processing a wastewater at a textile washing facility.

### DETAILED DESCRIPTION

This disclosure is generally directed to textile washing wastewater monitoring and recovery systems and associated techniques that allow at least a portion of the wastewater generated from a textile washer to be processed and recovered for reuse for cleaning a subsequent batch articles. In some implementations, wastewater generated by a single textile washer or a group of multiple textile washers may be processed through one or more wastewater treatment processes (e.g., located on-site with the textile washer(s) generated wastewater). The wastewater treatment processes may mechanically and/or chemically treat the wastewater to remove contaminants and/or solid particulates from the wastewater. Reference to wastewater and a textile washer generating waste water refers to used water that is discharged from a textile washer independent of whether the water is ultimately sent to waste or recycled or otherwise reused.

For example, the wastewater treatment processes may introduce one or more chemical agents that aggregate and/or flocculate contaminating matter present within the wastewater. This may include introducing one or chelating agents, coagulants, and/or flocculate agents to the wastewater to help coalesce contaminating matter present in the wastewater. One or more solid separation devices can be used separate solid material present in the wastewater. In some examples, the wastewater is processed through a dissolved air floatation system in which fine air bubbles are passed through the wastewater, raising flocculate particulate matter that can then be removed the is skimming or other technique. In some examples, the wastewater is processed through a membrane filtration system, such as microfiltration, nanofiltration, disc filtration, a carbon filter, a ceramic membrane filter, and/or other membrane filtration system. In either case, the one or more chemical and/or mechanical treatment processes applied to the wastewater can generate a clarified water. In typical practice, this clarified water may be discarded to a municipal sewer system.

In accordance with applications the present disclosure, the clarified water produced through one or more chemical and/or mechanical treatment processes applied to the wastewater generated by the one or more textile washers can be analyzed in at least a portion thereof recycle back to the one or more textile washers based on analysis of the water. For example, the system may utilize one or more sensors that can measure various characteristics of the clarified water indicative of the suitability of the water to be reused and further textile washing. Example characteristics include the turbidity and/or total suspended solids (TSS) of the water (e.g., indicative of the clarity of the water for producing clean textile articles if reused), the color of the water (e.g., indicative of the tendency of the water to discolor textiles if reused), and/or the chemical composition of the water such as pH and/or conductivity (e.g., indicative of the tendency of the water to interfere with one or more chemical agents used within the textile washer during the washing process if the waters reused).

In some examples, the clarified water is analyzed by measuring one or more characteristics relating to the suitability of the water to be recycled back to the one or more textile washers and reused in the washers when washing a subsequent batch of textile articles. For example, the system may automatically determine when the clarified water meets one or more preset standards stored in memory indicating the water is suitable to be recycled back to the one or more textile washers or, conversely, when the clarified water does not meet the one or more preset standards. Based on the analysis, the clarified water can be returned to the one or more textile washers from which the wastewater process to produce the clarified water was generated or, alternatively, the clarified water discarded. The clarified water may be discarded by dispensing the water to a sewer system or otherwise supplying the water to a location or application that does not involve recycling the water back to the one or more textile washers.

While a wastewater analysis and recovery system for a textile washing facility according to the disclosure can have a variety of different configurations, in some examples, the system is implemented in environment in which the wastewater generated by one or more textile washers at the textile washing facility is not treated through membrane filtration. For example, a variety of membrane filtration systems, such as reverse osmosis membrane filtration systems and ultrafiltration (UF) membrane filtration systems, may process wastewater and generate high purity filtered water suitable for any subsequent desired application. In practice, these membrane filtration systems may have high capital and/or operating costs, making implementation of such a membrane filtration system infeasible at a textile washing facility. Systems and techniques according to the present disclosure can, in some examples, be implemented without the capital and/or operating costs of a membrane filtration system to provide meaningful water savings to the operator of the textile washing facility. In some of these examples, the wastewater may be processed in a dissolved air flotation system or other clarifying system without being processed through a membrane filtration system. In other examples, however, the waste water may be processed in a membrane filtration system, such as using microfiltration, nanofiltration, disc filtration, a carbon filter, a ceramic membrane filter, and/or other membrane filtration system (optionally including or excluding reverse osmosis membrane filtration).

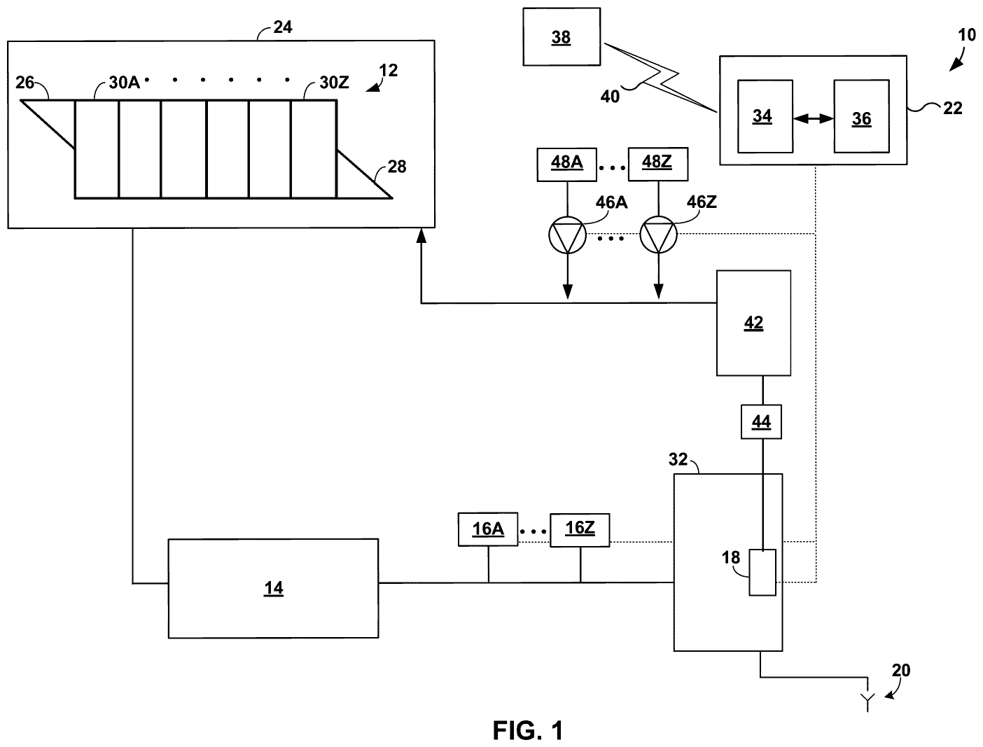

FIG. 1 is a conceptual diagram of an example water recovery system 10 for a textile washing facility. In the illustrated example, system 10 includes one or more textile washers 12, a wastewater treatment system 14, one or more sensors 16, a supply control device 18, a waste discharge 20, a controller 22. The one or more textile washers 12 (also referred to herein as “textile washer 12” or “washer 12” for simplicity), which may be implemented as a single textile washer or a plurality of textile washers, may be arranged on a wash floor of 24 in a single building or spread across multiple buildings. In operation, textile washer 12 can be loaded with textile articles. Water and one or more chemical additives can be introduced into the textile washer to wash textile articles in the washer. As a result of the washing process, textile washer 12 can generate wastewater that is discharged from the washer. The discharged water can be delivered via piping and/or other fluid connections to a wastewater treatment system 14. The wastewater can be chemically and/or mechanically treated as part of the wastewater treatment system, producing a clarified water. The one or more sensors 16 can measure one or more characteristics of the clarified water, and the clarified water can be recycled to textile washer 12 (e.g., by operation of supply control device 18) or discharged to waste discharge 20 based on the measured one or more characteristics. Controller 22 can manage the overall operation of system 10.

Textile washer 12 can be implemented using any suitable type of washer or combinations of types of washers, including a batch washer and/or a continuous washer. The textile washer can wash textiles such as clothing, linens, towels, blankets, and the like, which may be manufactured from natural fibers (e.g., wool, cashmere, cotton, silk, linen, hemp) and/or synthetic fibers (e.g., rayon, polyester, acrylic, acetate and nylon). In some examples, textile washer 12 includes a tunnel washer. A tunnel washer can be implemented as a continuous batch tunnel washer that includes a screw or conveying member to continuously transport articles being washed from an inlet 26 to outlet 28, e.g., while periodically holding the articles within a section of the wash chamber for agitation before moving onto the next section. Wash liquid within the tunnel washer may move in a co-current or counter-current direction through the washer. While FIG. 1 illustrates textile washer 12 as having a tunnel washer, in other applications, the system may additionally or alternatively utilize a centrifuge washing machines provided with a rotatable washing drum or yet other type of apparatus that provides mechanical agitation between washing liquid and the articles being washed. For example, a textile washer used may be a side-load textile washer with one or more processing chambers, an end loader washer/extractor, an open pocket washer/extractor, or yet other type of textile washing device.

When system 10 includes a tunnel washer, the interior of the tunnel washer may be divided into multiple zones, sections, pockets, or compartments, e.g., that provide processing chambers functioning as different stages of the washing process. For example, the tunnel washer may include multiple processing chambers 30A-30Z (collectively referred to as “processing chamber 30”) through which the textile articles being processed progresses during various wash and rinse cycles. While the illustrated tunnel washer is shown having six processing chambers 30, the washer may have fewer processing chambers (e.g., three, four, five) or more processing chambers (e.g., 8, 10, 12, or more).

To define the different processing stages 30 of the tunnel washer, an Archimedean screw may extend along the length of the tunnel washer with the helixes of the screw dividing the interior into different processing chamber. The tunnel washer can be mounted on rollers, allowing the tunnel washer to oscillate back and forth to agitate laundry articles within a given processing chamber 30 for a period of time. The tunnel washer may rotate 360 degrees periodically, causing the articles being processed to move from one processing chamber 30 to the next processing chamber. Alternatively, the screw may turn 360 degrees Forward instead of the tunnel washer housing to move the articles being processed from one stage to the next.

In general, the tunnel washer may include one or more wash chamber(s), one or more oxidizing chamber(s), and one or more rinse chamber(s) moving sequentially from inlet 26 to outlet 28. Within the one or more wash chambers, the articles being washed may be wetted and washed in the initial break step with detergents, surfactants, chelants, water conditioners, and/or alkalis, in each case with heating or unheated. After being washed, the articles may be conveyed downstream to the oxidizing chamber(s). Within the oxidizing chamber(s), antimicrobial agents, bleaches, chelants, water conditioners, pH adjustment acids/bases, and/or quaternary ammonium compounds may be added to clean and sanitize/disinfect the articles. The articles being washed can then be conveyed further down the tunnel washer to the rinse (and/or sour and/or finishing) chamber(s). Within the rinse/sour/finishing chamber(s), the articles may be rinsed with clean water, pH adjusted by adding antichlors and/or sour materials containing acid components that neutralize alkaline residues on the fabric, treated with a fabric softening agent, and/or treated with a bacteriostatic, mildewcide, and/or antistatic agent. In some examples, a separate neutralization processing chamber is provided downstream of the rinse processing chamber(s) for adjusting the pH of the articles before discharge. At the outlet 28 of the tunnel washer, a water extractor or press may remove excess water from the articles being washed, allowing the damp articles to be sent further downstream for drying, ironing, and/or steam finishing.

Each of the one or more textile washers 12 generate wastewater. Wastewater may be any water introduced into the textile washer and subsequently discharged from the textile washer. When textile washer 12 includes a tunnel washer, wastewater may be discharged from any of the one or more processing chambers 30. Wastewater discharge from the one or more textile washers may include residual chemistry introduced into the textile washer, solid particulate liberated from the articles being washed (e.g., fiber particles, soils), and/or other soils removed during the cleaning process. Example soils include dirt (e.g., sand), food and/or beverage deposits, bodily fluid, and/or other contaminants. Wastewater treated by system 10 may originate from locations other than textile washer 12 (e.g., an external water extractor) and be processed according to the techniques described herein.

The example system 10 of FIG. 1 includes a wastewater treatment system 14. Wastewater treatment system 14 can be fluidly connected to the one or more textile washers 12 on wash floor 24 and can receive wastewater from the textile washers for processing. Wastewater treatment system 14 may be implemented using one or more vessels and/or unit operations to chemically and/or mechanically treat the wastewater. For example, wastewater treatment system 14 may include a filter that removes course particulate from the wastewater (e.g., a screen such as a rotary drum screen, a shaker screen). Additionally or alternatively, wastewater treatment system 14 may include one or more chemical injections, such as an acid injection to the wastewater to neutralize a basic pH of the incoming wastewater, a coagulant injection, and/or other chemical injection. In some configurations, wastewater treatment system 14 includes a tank or other vessel that functions as an equalization tank to receive and collect wastewater from textile washer 12 before delivering water for further processing. When so configured, one or more chemical injections may be introduced into the tank.

In some configurations, wastewater treatment system 14 is or includes a dissolved air flotation system. In general, a dissolved air floatation system may operate by mixing a coagulant and/or flocculant with water being processed to flocculate waste matter (e.g., solid waste matter) contained in the water. The flocculated waste matter can then be raised with a flow of fine air bubbles. A removal device, such as a skim and/or weir, may be used to separate the waste floc from the residual water. Example chemical(s) that may be added to enhance solid remove include those improving coagulation and/or flocculation of particulate matter, such as clay, aluminum salts, ferric salts, activated silica, organic polymers, inorganic polymers, and combinations thereof. In some examples, the dissolved air floatation system includes a separate mix tank upstream of a float tank. The one or more chemicals can be added to the wastewater in the mix tank and mixed (e.g., stirred) before delivering the wastewater to a float tank where air is bubbled through the wastewater.

Additionally or alternatively, wastewater treatment system 14 is or may include a membrane filtration system. Any suitable membrane filtration system may be used in these applications, and the disclosure is not limited in this respect. Example membrane filtration systems that may be used include, but are not limited to, microfiltration, nanofiltration, disc filtration, a carbon filter, and/or a ceramic membrane filter.

Independent of the configuration of wastewater treatment system 14, including the specific configuration of a dissolved air flotation system that may be used for or as part of the wastewater treatment system, the wastewater treatment system can produce a clarified water. The clarified water may be a water having a reduced solid content as compared to the wastewater discharged from the one or more textile washers 12 and therefore is clarified relative to the originally discharged wastewater. For example, depending on the type of wastewater treatment system 14 used, the amount of total suspended solids (TSS) removed from the incoming wastewater compared to the outgoing clarified water may be within a range of 80% to 99%, such as from 85% to 95%. As a result, the clarified water may have from 1% to 20% of the TSS load of the wastewater processed to generate the clarified water, such as from 5% to 15%. The foregoing values are examples of the disclosure is not limited in this respect.

To control selective recycling of the wastewater generated by the one or more textile washers 12 (e.g., the clarified water generated through treatment of the wastewater by wastewater treatment system 14), system 10 may include one or more sensors 16. System 10 in FIG. 1 is illustrated as including sensors 16A-16Z (collectively “sensor 16”). Each sensor 16 can measure one or more characteristics of the clarified water to provide one or more measured characteristics of the clarified water. System 10 can include a single sensor 16 or a plurality of sensors 16 (e.g., two, three, or more). In either case, each such sensors 16 may provide data indicative of the quality of the clarified water for recycle and reuse in system 10. For example, each such sensors 16 may provide data indicative of the presence of contaminants in the clarified water which, if the clarified water were recycled to textile washer 12, may result in textile articles being processed in the textile washer with the recycled water not being properly cleaned.

A variety of different sensors or combinations of sensors 16 may be implemented to measure characteristics of the clarified water providing information that can be used to determine whether to recycle or discard the clarified water. In some examples, sensor 16 includes one or more optical sensors configured to measure one or more optical characteristics of the clarified water. For example, sensor 16 may measure a characteristic indicative of the color of the water, such as absorbance and/or transmittance of the water at one or more wavelengths. Sensor 16 may measure the characteristic indicative of the color at one or more single wavelengths (e.g., corresponding to colors of concern for water reuse) or across a spectrum of wavelengths, which may be in the UV spectrum (e.g., the range from approximately 200 nm to approximately 400 nanometers), the visible spectrum (e.g., approximately 400 nm to approximately 700 nm), and/or the infrared spectrum (e.g., from approximately 700 nm to approximately 1000 nm).

In some examples, sensor 16 may measure a characteristic indicative of the color of the water at two or more wavelengths (e.g., three or more wavelengths). The wavelengths may correspond to a color selected from the group consisting of red, yellow, blue, and combinations thereof. For instance, in some implementations, sensor 16 may measure a characteristic indicative of the color of the water at a first wavelength within a range from 385 nm to 425 nm, such as from 395 nm to 415 nm, or 405 nm, at a second wavelength within a range from 490 nm to 530 nm, such as from 500 nm to 520 nm, or 510 nm, and/or at a third wavelength within a range from 580 nm to 620 nm, such as from 590 nm to 610 nm, or 600 nm. The first wavelength range can correspond to a yellow color, the second wavelength range can correspond to a red color, and the third wavelength range can correspond to a blue color.

When using an optical sensor 16 to make a measurement indicative of color, the configuration of the sensor can vary in the measurement data generated by the sensor can be processed in a variety of ways. In some examples, the characteristic indicative of color comprises the ratio of transmittance or absorbance values measured for two wavelengths. For example, the ratio may be or include one wavelength selected in the visible range and another wavelength selected in the ultraviolet range. Depending on the configuration of the sensor, transmittance or absorbance values may be measured within a flow cell, such as a flow cell have a path length within a ranges from 10 mm to 200 mm. In some examples, two or more light-emitting diodes (LEDs) are positioned at opposite sides of the flow cell.

In some examples, optical measurements made by sensor 16 indicative of color are adjusted based on a measured turbidity and/or total suspended solids of the wastewater. For example, one or more measured optical characteristics indicative of color (e.g., transmittance, absorbance) may be adjusted based on one or more measured characteristics indicative of the turbidity of the water (where total suspended solids also provides an indication of the turbidity of the water). This adjustment can help compensate for light reflection and/or other effects of the turbidity on the color measurement.

Measuring one or more characteristics of the clarified water indicative of color can be useful to avoid inadvertent staining of textile articles if unsuitably colored water is recycled back to textile washer 12. For example, if the clarified water is not sufficiently color neutral but, instead, contains dyes and/or pigments from a subsequent wash cycle that may have a tendency to discolor a subsequent batch of textile articles being cleaned, such water may not be suitable for recycle and may instead be discarded.

Additionally or alternatively, where one or more colors corresponding to one or more wavelengths are measured by optical sensor 16, controller 22 may compare the measured color(s) of the clarified water to information concerning the color of the textile articles to be washed if the clarified water were to be recycle. Controller 22 may be informed of the color of textile articles to be washed via a user provided information from a user interface and/or communication with the electronic batch scheduling system. If controller 22 determines with reference to stored information that the color of the clarified water as indicated by one or more characteristics indicative of color measured by sensor 16 is suitable for the textile articles to be washed upon reuse the water (e.g., will not cause undesirable staining), controller 22 may control the system to recycle the clarified water. By contrast, if controller 22 determines that the color of the clarified water indicated by one or more characteristics indicative of color measured by sensor 16 is not suitable for the textile articles to be washed, controller 22 may control the system to supply the clarified water to waste discharge 20 and/or further processing.

For instance, in lieu of discharging the clarified water that is not initially indicated as suitable for recycle to textile washer 12 to waste discharge 20, controller 22 may control delivery of the clarified water to one or more unit operations configured to improve the quality of the water to a level effective to allow the water to be reused. For example, the operator may utilize a filtration system (e.g., continuous microfiltration system) through which a portion of the clarified water unsuitable for recycle can be processed to improve the quality of the water to a level suitable to allow the portion of the water to be recycle.

In addition to or in lieu of measuring a characteristic indicative of the color of the clarified water, sensor 16 may be implemented using an optical sensor to provide a measurement indicative of a concentration and/or size of particles in the cooling water. For example, sensor 16 may be used to measure the turbidity and/or light scatting characteristics of the clarified. An increased concentration of particulate in the clarified water may indicate the relative cleanliness of the water and, correspondingly, suitability for recycle and reuse.

A variety of other types of sensors may be utilized as sensor 16, including one or more sensors to measure a pH of the clarified water, an oxidative reductive potential (ORP) of the water (e.g., conductivity probe measurements), a sensor to measure total dissolved solids (TDS) of the water, a sensor (e.g., optical sensor) to measure total suspended solids (TSS) of the water, a sensor to measure suspended fat, oil, and grease (FOG), a sensor to measure a concentration of one or more metals (e.g., iron), and/or other suitable sensor.

Each sensor 16 can be implemented in number of different ways in system 10. For example, one or more of the sensors can be positioned in line with clarified water flowing from wastewater treatment system 14 either directly or via a slipstream pulled from the main cooling water stream. Additionally or alternatively, one or more sensors can be positioned to measure the clarified water in a vessel containing a level of the clarified (e.g., a vessel associated with wastewater treatment system 14 or downstream collection vessel). For example, the one or more sensors can be positioned to measure a characteristic of the clarified water in a dissolved air floatation tank, a downstream receiving vessel 32 as will be discussed, and/or other vessel. Additionally or alternatively, one or more of the sensors may be implemented as an off-line monitoring tool that is not in direct fluid communication with clarified water flowing from water treatment system 14. In in these applications, a sample of the clarified water may be extracted from the system and transported to an off-line analysis system. Such off-line analysis may involve direct evaluation of the sample, e.g., using one or more sensors, or may involve further processing on the sample. In either case, data generated by sensor 16 and/or otherwise associated with clarified water under evaluation can be received by controller 22, e.g., for storage in memory and/or further processing.

Independent of the specific way in which each of the one or more sensor 16 are implemented in system 10, the sensors may measure one or more characteristics of the water between water treatment system 14 and supply control device 18. This can provide feedback information concerning the suitability of the water for recycle that can then be used to control supply control device 18 for directing the clarified water to one of multiple different destination locations, such as recycled to textile washer 12 or delivery to waste discharge 20.

In general, supply control device 18 may be implemented using any device or combination of devices operable to control the delivery of clarified water to a selectable one of multiple different locations. In some examples, supply control device 18 is implemented using one or more valves operating under the control of controller 22. The one or more valves may open and/or close to open and/or close fluid communication through piping connecting wastewater treatment system 14 to downstream locations, such as textile washer 12 and waste discharge 20. In response to controller 22 determining based on information generated by the one or more sensor 16 that the clarified water should be recycled to textile washer 12 or discharge to waste discharge 20, controller 22 can control the one or more valves to direct the clarified water to the selected destination location.

Additionally or alternatively, supply control device 18 may be implemented using one or more pumps. The one or more pumps can operate under the control of controller 22. The one or more pumps can be fluidly connected to wastewater treatment system 14, e.g., directly or indirectly. In response to controller 22 determining based on information generated by the one or more sensor 16 that the clarified water should be recycled to textile washer 12 or discharge to waste discharge 20, controller 22 can control the one or more pumps (e.g., turn one or more pumps on and/or off) to direct the clarified water to the selected destination location.

In the example of FIG. 1, system 10 is illustrated as being implemented with a receiving vessel 32 fluidly connected to wastewater treatment system 14. Receiving vessel 32 may be a tank, pit, or other reservoir suitable to receive and hold a volume of clarified water. In some examples, receiving vessel 32 functions as an equalization tank to equalize inconsistent flows of clarified water produced by water treatment system 14. In some examples, receiving vessel 32 functions as a waste tank that collects clarified water and, optionally, acts as a gravity separator to further gravity separate additional particulate from the clarified water before discharging the water. While system 10 in the example of FIG. 1 is illustrated as being implemented with receiving vessel 32, other configurations of the system may not utilize such a vessel. Rather, in these examples, effluent by be drawn and/or diverted directly from an effluent tubing line without providing a separate receiving vessel.

When configured with receiving vessel 32, supply control device 18 may be or include a pump fluidly connected to the receiving vessel. The pump may be external to the receiving vessel and connected to the vessel via piping to a port of the vessel. The pump may be internal to the receiving vessel, such as a submersible pump. In either case, the pump may operate under the control of controller 22 to draw clarified water on a source side of the pump, pressurize the water, and discharge the pressurized water on a discharge side of the pump for delivery to a downstream location fluidly connected to the discharge of the pump via piping. When so configured, the one or more pumps may be fluidly connected, directly or indirectly, to the one or more textile washers 12 and/or waste discharge 20.

In some implementations, receiving vessel 32 is fluidly connected to waste discharge 20, e.g., via piping from a port of the vessel, and can gravity drain clarified water from the receiving vessel to waste discharge 20. In these implementations, controller 22 may be communicatively coupled to a pump operable to pump clarified water out of receiving vessel 32 and to deliver the pump water to textile washer 12. Controller 22 may also be communicatively coupled to a valve operable to control discharge of clarified water out of receiving vessel 32 and to deliver the water to waste discharge 20 (e.g., under the force of gravity). In these implementations, the one or more pumps and valves may collectively provide the functionality of supply control device 18 operable to control the delivery of clarified water to the selected one of at least two different delivery locations.

Waste discharge 20 may be any desired discharge location for clarified water not desired to be recycled to textile washer 12. In some examples, waste discharge 20 represents a discharge to a sewer, such as a sewer line fluidly connected to a private or public (e.g., municipal) sewer system they can receive the clarified water for direct environmental discharge for further processing before reuse or environmental discharge. In other examples, waste discharge 20 may represent a destination location for the clarified water where the clarified water can be beneficially utilized on site without being recycled to textile washer 12.

System 10 in the example of FIG. 1 also includes controller 22. Controller 2 can be communicatively connected to sensor 16, supply control device 18, and/or other controllable components of system 10 to manage the overall operation of the system. Controller 22 includes a processor 34 and a memory 36. Controller 22 can communicate with communicatively connected components via a wired and/or wireless connection, which in the example of FIG. 1 is illustrated as a wired connection. Controls signals sent from controller 22 and received by the controller can travel over the connection. Memory 36 can store software for running controller 22 and may also store data generated or received by processor 34, e.g., from sensor 16. Processor 34 can run software stored in memory 36 to manage the operation of system 10.

Controller 22 may be implemented using one or more controllers, which may be located at the facility site containing textile washer 12. Controller 22 may communicate with one or more remote computing devices 38 via a network 40. For example, controller 22 may communicate with a geographically distributed cloud computing network, which may perform any or all of the functions attributed to controller 22 in this disclosure.

Network 40 can be configured to couple one computing device to another computing device to enable the devices to communicate together. Network 40 may be enabled to employ any form of computer readable media for communicating information from one electronic device to another. Also, network 40 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. Communication links within LANs may include twisted wire pair or coaxial cable, while communication links between networks may utilize analog telephone lines, full or fractional dedicated digital lines, Integrated Services Digital Networks (ISDNs), Digital Subscriber Lines (DSLs), wireless links including cellular and satellite links, or other communications links. Furthermore, remote computers and other related electronic devices may be remotely connected to either LANs or WANs via a modem and temporary telephone link.

In operation, the one or more sensors 16 can generate data indicative of one or more characteristics of the clarified water. Controller 22 can receive data from the sensors indicative of the one or more characteristics measured by the one or more sensors 16. Controller 22 can analyze the data measured by the one or more sensors 16 with reference to information stored in memory 36, e.g., to determine whether to recycle the clarified water to the one or more textile washers 12 or whether to discard the clarified water to waste discharge 20.

Controller 22 can control the supply of clarified water to a selected one of multiple different destination locations based on measurements made by the one or more sensors 16. For example, controller 22 can analyze one or more measured characteristics of the clarified water with reference to information stored in memory 36. Based on the analysis, controller 22 can control system 10 to direct the clarified water to the selected one of textile washer 12 (in which case the water is recycled back to the textile washer for reuse), to waste discharge 20, and/or to another selected destination location. Controller 22 can control supply device 18 to control the supply of the clarified water to the selected destination location.

Controller 22 has generally been described as controlling the supply of the clarified water to only one destination location (at a particular time and/or for a particular batch of clarified water) without supplying the clarified water to a second destination location, it should be appreciated that the disclosure is not limited in this respect. In some implementations, controller 22 may control supply control device 18 to supply the clarified water to multiple destination locations (e.g., simultaneously), such as recycling back to textile washer 12 and delivering to waste discharge 20. For example, controller 22 may determine a proportioning or allocation of the clarified water between recycle and reuse to textile washer 12 and waste discharge 20 based on one more measured characteristics of the clarified water from sensor 16.

For example, controller 22 may determine based on measurement information on the one or more characteristics of the clarified water from sensor 16 that a full amount of the available clarified water is not suitable to recycled back to textile washer 12 (e.g., because the quality of the water is not sufficient to use in comparatively large quantities in the textile washer). However, controller 22 may determine based on the measurement information that at least a portion of the available clarified water can be recycled back to textile washer 12 (e.g., and be combined with freshwater). Controller 22 can then control supply control device 18 to proportion the clarified water between recycle and waste discharge. The relative proportioning of the clarified water between recycle and waste discharge may be determined by controller 22 with reference to information stored in memory based on the quality of the water as indicated by the one or more measured characteristics.

Accordingly, in system 10, clarified water produced by water treatment system 14 may be segregated with a first portion of the clarified water being returned to textile washer 12 for reuse and a second portion of the clarified water being delivered to waste discharge 20 for discard. In typical practice, the portion of water recycled to textile washer 12 may be time separated from the portion of water delivered to waste discharge 20. For example, the composition and/or quality of the wastewater and/or clarified water being processed by system 10 may vary over time (e.g., with one or more characteristics a continuous flow the wastewater and/or clarified water changing over time and/or one or more characteristics of the wastewater and/or clarified water changing batch-to-batch). The characteristics of the water may change as the type of articles wash (e.g., type of fabric, color of fabric, type of soiling, magnitude of soiling) change. Accordingly, sensor 16 may periodically measure, and controller 22 may receive, information concerning characteristics of the clarified water over time as the composition of the clarified water changes. Controller 22 may control supply delivery device 18 to change where the clarified water is being delivered, e.g., such that some or all of the clarified water is recycled to textile washer 12 (e.g., without delivering the clarified water to waste discharge 20), some or all of the clarified water is delivered to waste discharge 20 (e.g., without delivering the clarified water to waste discharge 20), or some of the clarified water is recycled to textile washer 12 and some of the clarified water is delivered to waste discharge 20. Controller 22 can control supply deliver device 18 to change the supply of clarified water (e.g., among any of the aforementioned options) as the composition of the water changes based on measured information received from sensor 16.

Controller 22 may receive information from sensor 16 and control supply control device 18 based on the received information at any suitable frequency. As examples, controller 22 may receive information from sensor 16 and control supply control device 18 based on the received information at least once every minute, such as at least once every 30 seconds, at least once every 10 seconds, or at least once every 5 seconds. Multiple measurements made by sensor 16 may be averaged together to generate time-averaged measurement datapoints for making comparisons and/or control decisions. Additionally or alternatively, controller 22 may include a user interface that allows an operator to interact with the controller to receive information from sensor 16 and control supply control device 18 based on the received information on demand.

Controller 22 can analyze measurement information generated by the one or more sensors 16 with reference to information stored in memory 36 to determine where to supply clarified water among the different available delivery destination options in system 10. In some examples, controller 22 compares one or more measured characteristics to one or more thresholds stored in memory 36. The one or more thresholds stored in memory 36 may be associated with values for the one or more measured characteristics and correspond to the quality and/or suitability of the clarified water for recycle. The one or more thresholds may be determined based on analysis of various clarified water samples having differing quality levels (e.g., compositions and/or characteristics) related to the suitability of the water to be reused in textile washer 12. The one or more thresholds may establish limits as to whether the clarified water can be reused in textile washer 12 (e.g., as opposed to being supplied to waste discharge 20) and/or the amount of clarified water that can be used in textile washer 12 (e.g., when proportioning between the textile washer and waste discharge).

For example, when sensor 16 is configured to measure a characteristic indicative of the color of the clarified water, controller 22 may compare the measured characteristic indicative of color to one or more color thresholds in memory 36. When sensor 16 is configured to measure a characteristic indicative of the turbidity of the clarified water, controller 22 may compare the measured characteristic indicative of turbidity (e.g., an optical turbidity measurement, a total suspended solids measurement) to one or more turbidity thresholds in memory 36. In either case, controller 22 may control supply control device 18 based on the one or more thresholds.

For example, controller 22 can control supply control device 18 to supply the clarified water to textile washer 12 (e.g., without supplying the water to waste discharge 20) for reuse if the measured characteristic is within a range associated with the one or more thresholds (e.g., thereby indicating the water is suitable for reuse). Controller 22 can control supply control device 18 to supply the clarified water to waste discharge 20 (e.g., without supplying the water to textile washer 12) if the measured characteristic is outside of a range associated with the one or more thresholds (e.g., thereby indicating the water is unsuitable for reuse).

For example, controller 22 can compare one or more measured characteristics indicative of color to one or more color thresholds. In some examples, the characteristic indicative of color comprises absorbance. Color absorbency measurements can be made in accordance with ASTM 169-16. Depending on the application, an acceptable color threshold for a facility may be a measured absorbance less than 1.0, such as less than 0.75, less than 0.6, less than 0.5, less than 0.4, less than 0.3, less than 0.25, less than 0.2, or less than 0.1. If the measured color characteristic is within the threshold (e.g., at or below the required threshold), controller 22 may control the system to direct the water to be reused. By contrast, if the measured color characteristic is outside of the threshold (e.g., above the required threshold), controller 22 may control the system direct the water to be discarded.

In some examples, controller 22 compares multiple measured characteristics indicative of color to multiple corresponding thresholds. For example, controller 22 may compare a first measured absorbance or transmittance at the first wavelength to a first threshold, a second measured absorbance or transmittance at the second wavelength to a second threshold, and/or a third measured absorbance or transmittance at the third wavelength to a third threshold. If all of the measured absorbances or transmittances are within the corresponding threshold amounts, controller 22 may control the system to allow the water to be reused. By contrast, if any one of the multiple measured absorbances or transmittances are outside of the corresponding threshold amounts, controller 22 may control the system direct the water to be discarded.

Additionally or alternatively, controller 22 can compare one or more measured characteristics indicative of turbidity to one or more turbidity thresholds. In some examples, the characteristic indicative of turbidity is measured in nephelometric turbidity units (NTU). Turbidity measurements can be made in accordance with D7315-17. Depending on the application, an acceptable turbidity threshold for a facility may be a measured turbidity less than 300 NTU, such as less than 250 NTU, less than 200 NTU, less than 150 NTU, less than 100 NTU, or less than 50 NTU. If the measured turbidity characteristic is within the threshold (e.g., at or below the required threshold), controller 22 may control the system to direct the water to be reused. By contrast, if the measured turbidity characteristic is outside of the threshold (e.g., above the required threshold), controller 22 may control the system direct the water to be discarded.

In some examples, controller 22 can compare one or more measured characteristics indicative of color to one or more color thresholds and compare one or more measured characteristics indicative of turbidity to one or more turbidity thresholds. For example, controller 22 may compare a first characteristic indicative of a color of the clarified water and a second characteristic indictive of one or both of a turbidity and a total suspended solids of the clarified water to corresponding first and second thresholds. If both the first and second characteristics are within their required thresholds (e.g., at or below each required threshold), controller 22 may control the system to direct the water to be reused. By contrast, either of the first and second characteristics is outside of their required threshold (e.g., above the required threshold), controller 22 may control the system direct the water to be discarded. When so configured, the clarified water may need to satisfy both a color requirement and a turbidity requirement to quality to be reused.

The portion of the clarified water directed to be recycled to textile washer 12 (through the control of supply control device 18) may be referred to as a reuse water. Accordingly, discussion of recycling wastewater, clarified water, and/or reuse water to textile washer 12 may refer to the same underlying source water albeit at different points in the process. As such, discussion of recycling wastewater to textile washer 12 may be replaced by corresponding terminology regarding recycling clarified water and/or reuse water, e.g., to further clarify process step performed in system 10 on the wastewater prior to being received at textile washer 12.

In either case, the reuse water may be delivered from supply control device 18 directly to textile washer 12 (e.g., wash floor 24) or may pass through one or more intermediate devices and/or unit operations. In the illustrated example of FIG. 1, system 10 includes a collection vessel 42 that receives reuse water from supply control device 18 and from which textile washer 12 is supplied with reuse water. Collection vessel 42 may be a tank or other reservoir that provides a collected volume of reuse water.

System 10 in FIG. 1 also illustrates an example filtration unit 44 positioned between supply control device 18 and textile washer 12. Filtration unit 44 may filter the reuse water to help polish the water before returning to textile washer 12. Filtration unit 44 may be implemented using a variety of different technologies, such as a centrifuge, a membrane filter, a bag filter, and/or other filtration device.

Reuse water may be supplied to textile washer 12 without further processing or chemical modification except for the treatment provided by water treatment system 14 upstream of supply control device 18 and/or optional filtration unit 44. In other examples, including the example of FIG. 1, one or more sensors 46A-46Z (collectively “sensor 46”) can be positioned to measure one or more characteristics of the reuse water to provide one or more measured characteristic of the reuse water. Sensor 46 may or may not provide information different than the information provided by sensor 16. For example, sensor 46 may measure one or more characteristics of the reuse water indicative of a concentration of one or more chemical components present in the reuse water and, correspondingly, the compatibility of the reuse water with chemical additives to be added to textile washer 12 as part of the washing process. For example, the one or more sensors 46 may measure a pH of the reuse water, a temperature of the reuse water, a conductivity of the reuse water (e.g., an oxidative reductive potential (ORP) of the reuse water, a total dissolved solids level of the reuse water, a total dissolved solids level of the reuse water, and/or other desired characteristic.

Controller 22 can be communicatively coupled to the one or more sensors 46. In operation, the one or more sensors 46 can generate data indicative of one or more characteristics of the reuse. Controller 22 can receive data from the sensors indicative of the one or more characteristics measured by the one or more sensors 46. Controller 22 can analyze the data measured by the one or more sensors 46, e.g., with reference to information stored in memory 36. In some implementations, controller 22 compares the one or more characteristics with one or more corresponding thresholds stored in memory 36, as discussed above with respect to example analysis of sensor data from sensor 16 by controller 22.

Information concerning the one or more characteristics measured by the one or more sensors 46 may be output to a user, e.g., via a user interface associated with controller 22, for visualization. In some examples, system 10 may include one or more pumps fluidly connected to one or more reuse water addition sources operable to add the one or more reuse water addition sources to the reuse water based on the one or more characteristics measured by sensors 46.

For example, in the configuration of FIG. 1, system 10 includes one or more pump 48A-48Z (collectively referred to as “pump 48”) fluidly connected to one or more respective reuse water addition sources 50A-50Z (collectively referred to as “reuse water addition source 50”). Pump 48 can operate to add one or more of the reuse water addition sources to the reuse water. For example, controller 22 can control pump 48 to control addition of the one or more reuse water addition sources 50 to the reuse water based on the one or more measured characteristic of the reuse water from sensor 46.

The one or more reuse water addition sources 50 may be selected as those effective to modify the chemical composition of the reuse water, thereby adjusting one or more measured characteristics of the reuse water from being outside a threshold limit to being within an acceptable threshold range (e.g., which be a bounded or unbounded range). Examples of pH adjusting control agents include mineral acids, organic acids, and inorganic bases. Examples of conductivity adjusting chemicals include fresh water (e.g., thereby diluting the reuse water and changing the conductivity of the composite water) and/or other charged chemical agents.

In the illustrated configuration of FIG. 1, pump 48 is illustrated as adding reuse water addition source 50 to the reuse water between collection vessel 42 and textile washer 12. In practice, the reuse water addition source 50 may be introduced to the reuse stream at any suitable location, in collection vessel 42 or in textile washer 12 (e.g., by adjusting the type and/or amount of chemistry introduced into the textile washer, such as the amount of sour or base introduced into the textile washer, based on the characteristic(s) measured by sensor 46).

System 10 may include additional and/or different sensors to measure different operational parameters in the system. For example, the system may include one or more flow sensors to measure the flow rate of water at various locations in the system (e.g., to measure the amount of reuse water recycled to textile washer 12, to measure the amount of the clarified water sent to waste discharge). As another example, system 10 may include a pH sensor and temperature sensor (e.g., the measure the pH and/or temperature of the clarified water sent to waste discharge).

A variety of different processing steps may be performed on the reuse water to remove one or more impurities prior to supplying the reuse water back to textile washer 12. In some examples, the reuse water is chemically treated, e.g., to modify the pH of the reuse water to precipitate impurities, to chemical react one or more species to change, remove, and/or otherwise neutralize color, to chelate metal species, and/or the like. Additionally or alternatively, one or more physical separation processes are performed on the reuse water such as, e.g., filtration, flotation, and/or solids separation.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a non-transitory computer-readable storage medium, containing instructions. Instructions embedded or encoded in a computer-readable storage medium may cause a programmable processor, or other processor, to perform the method, e.g., when the instructions are executed. Non-transitory computer readable storage media may include volatile and/or non-volatile memory forms including, e.g., random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

The following examples may provide additional details about water monitoring and control systems and techniques according to the disclosure.

### EXAMPLE

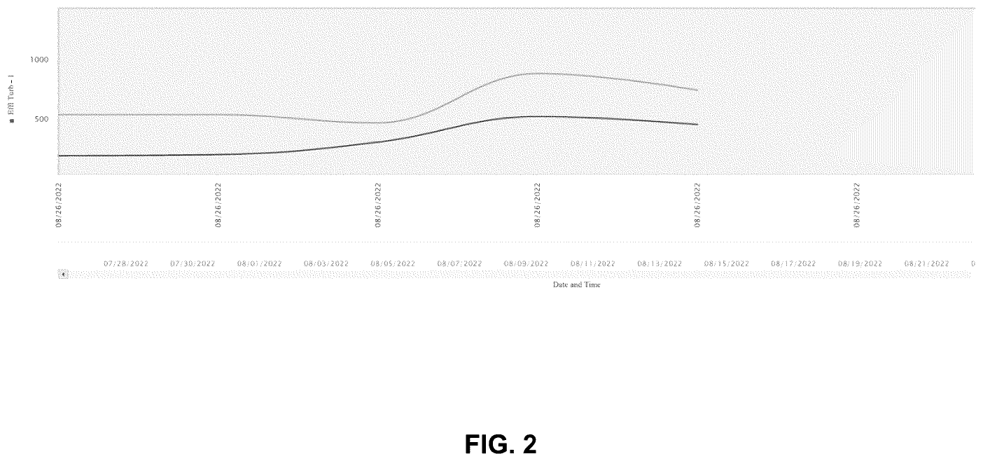

FIG. 2 is a plot of turbidity versus time for a clarified water measured downstream of a dissolved air floatation system processing a wastewater at a textile washing facility.

1. A method comprising:
receiving wastewater generated by one or more textile washers;
processing the wastewater to remove particulates from the wastewater to generate a clarified water;
measuring one or more characteristics of the clarified water to provide one or more measured characteristics of the clarified water; and
controlling supply of the clarified water based on the one or more measured characteristics to either (a) return the clarified water to the one or more textile washers for reuse or (b) discard the clarified water.

2. The method of claim 1, wherein processing the wastewater to remove particulates from the wastewater to generate the clarified water comprises processing the wastewater in a dissolved air floatation system to remove particulates from the wastewater to generate the clarified water.

3. The method of claim 1, wherein processing the wastewater to remove particulates from the wastewater to generate the clarified water comprises processing the wastewater through a membrane filtration system to remove particulates from the wastewater to generate the clarified water.

4. The method of claim 1, wherein measuring one or more characteristics of the clarified water comprises measuring an optical characteristic of the clarified water using an optical sensor.

5. The method of claim 4, wherein the optical characteristic is a characteristic indicative of a color of the clarified water.

6. The method of claim 5, wherein the one or more measured characteristics of the clarified water comprises a measured characteristic indicative of color, and further comprising comparing the measured characteristic indicative of color to one or more color thresholds, wherein controlling supply of the clarified water based on the one or more measured characteristics comprises controlling supply of the clarified water based on comparison of the measured characteristic indicative of color to the one or more color thresholds.

7. The method of claim 6, wherein controlling supply of the clarified water based on the one or more measured characteristics to either (a) return the clarified water to the one or more textile washers for reuse or (b) discard the clarified water comprises:
supplying the clarified water to the one or more textile washers for reuse if the measured characteristic indicative of color is within a range associated with the one or more color thresholds; and
supplying the clarified water to discard if the measured characteristic indicative of color is outside of a range associated with the one or more color thresholds.

8. The method of claim 5, wherein measuring one or more characteristics of the clarified water indicative of the color of the clarified water comprises measuring at least one of an absorbance and a transmittance of the clarified water at two or more wavelengths.

9. The method of claim 8, wherein the two or more wavelengths are wavelengths indicative of a color selected from the group consisting of red, yellow, blue, and combinations thereof.

10. The method of claim 4, wherein the optical characteristic is one or both of turbidity and total suspended solids and the one or more measured characteristics comprises one or both of a measured turbidity and a measured total suspended solids, and further comprising comparing one or both of the measured turbidity to one or more turbidity thresholds and the measured total suspended solids to one or more total suspended solids thresholds, wherein controlling supply of the clarified water based on the one or more measured characteristics comprises controlling supply of the clarified water based on comparison of one or both of the measured turbidity to the one or more turbidity thresholds and the measured total suspended solids to one or more total suspended solids thresholds.

11. The method of claim 1, wherein:
the one or more measured characteristics comprise a first characteristic indicative of a color of the clarified water and a second characteristic indictive of one or both of a turbidity and a total suspended solids of the clarified water; and
controlling supply of the clarified water based on the one or more measured characteristics comprises controlling supply of the clarified water based on both the first characteristic and the second characteristic.

12. The method of claim 11, further comprising:
comparing the first characteristic to at least one first characteristic threshold;
comparing the second characteristic to at least on second characteristic threshold;
supplying the clarified water to the one or more textile washers for reuse if the first characteristic is within the at least one first characteristic threshold and the second characteristic is within the at least one second characteristic threshold; and
supplying the clarified water to discard if either the first characteristic is outside of the at least one first characteristic threshold or the second characteristic is outside of the at least one second characteristic threshold.

13. The method of claim 1, wherein measuring one or more characteristics of the clarified water comprises measuring a non-optical characteristic of the clarified water comprising one or both of (a) a metal concentration in the clarified water and (b) a fat, oil, and grease concentration in the clarified water.

14. The method of claim 1, wherein controlling supply of the clarified water based on the one or more measured characteristics comprises at least one of (a) controlling a valve directing the clarified water to either return to the one or more textile washers or directing the clarified water to discard or (b) controlling a pump to pump the clarified water for return to the one or more textile washers.

15. The method of claim 1, further comprising delivering the clarified water to a receiving vessel, wherein controlling supply of the clarified water based on the one or more measured characteristics comprises supplying the clarified water from the receiving vessel to either the one or more textile washers for reuse or to discard.

16. The method of claim 15, wherein measuring one or more characteristics of the clarified water to provide one or more measured characteristics of the clarified water comprises measuring one or more characteristics of the clarified water in the receiving vessel.

17. The method claim 1, wherein a portion of the clarified water returned to the one or more textile washers for reuse defines a reuse water, and further comprising measuring one or more characteristics of the reuse water to provide one or more measured characteristic of the reuse water.

18. The method of claim 17, further comprising controlling a composition of the reuse water based on the one or more measured characteristics.

19. The method of claim 1, wherein a portion of the clarified water returned to the one or more textile washers for reuse defines a reuse water, and further comprising processing the reuse water to remove one or more impurities prior to supplying the reuse water to the one or more textile washers.

20. The method of claim 19, wherein processing the reuse water to remove one or more impurities comprises chemically treating the reuse water.

21. The method of claim 19, wherein processing the reuse water to remove one or more impurities comprises performing a physical separation process on the reuse water.

22. The method of claim 1, wherein controlling supply of the clarified water based on the one or more measured characteristics to either (a) return the clarified water to the one or more textile washers for reuse or (b) discard the clarified water comprises returning a first portion of the clarified water to the one or more textile washers for reuse and sending a second portion of the clarified water to discard.

23. A water recovery system for a textile washing facility, the system comprising:
one or more textile washers configured to wash textile articles and produce a wastewater;
a waste water treatment system fluidly connected to the one or more textile washers and configured to receive the wastewater produced by the one or more textile washers, remove particulates from the wastewater, and generate a clarified water;
one or more sensors positioned to measure one or more characteristics of the clarified water to provide one or more measured characteristics of the clarified water;
a supply control device configured to control return of the clarified water to the one or more textile washers for reuse;
a waste discharge; and
a controller communicatively coupled to the one or more sensors and the supply control device, the controller being configured to:
receive data from the one or more sensors indicative of the one or more measured characteristics of the clarified water; and
control the supply control device based on the one or more measured characteristics to either (a) return the clarified water to the one or more textile washers for reuse or (b) discard the clarified water to the waste discharge.

24. The system of claim 23, wherein the waste water treatment system comprises a dissolved air floatation system.

25. The system of claim 23, wherein the waste water treatment system comprises a membrane filtration system.

26. The system of claim 23, wherein the one or more sensors comprise an optical sensor configured to measure an optical characteristic of the clarified water.

27. The system of claim 26, wherein the optical characteristic comprises a characteristic indicative of a color of the clarified water.

28. The system of claim 27, wherein the controller is configured to:
compare the characteristic indicative of color to one or more color thresholds; and
control the supply control device based on the one or more measured characteristics by at least controlling the supply device based on comparison of the characteristic indicative of color to the one or more color thresholds.

29. The system of claim 26, wherein the optical characteristic comprises one or both of turbidity and total suspended solids, and the controller is configured to:
compare one or both of the turbidity and the total suspended solids to one or both of one or more turbidity thresholds or one or more total suspended solids thresholds; and
control the supply control device based on the one or more measured characteristics by at least controlling the supply device based on comparison of one or both of the turbidity and total suspended solids to the one or more turbidity thresholds or the one or more total suspended solids thresholds.

30. The system of claim 26, wherein:
the one or more characteristics comprise a first characteristic indicative of a color of the clarified water and a second characteristic indictive of one or both of a turbidity and a total suspended solids of the clarified water; and
the controller is configured to control the supply control device based on both the first characteristic and the second characteristic.
